(19) United States
(12) Patent Application Publication
(10) Pub. No.: US 2023/0268733 A1
(43) Pub. Date: Aug. 24, 2023

(54) ENERGY DISTRIBUTION SYSTEM

(71) Applicants: Siemens Energy Global GmbH & Co. KG, Munich, Bayern (DE); Siemens Energy AS, Oslo (NO)

(72) Inventors: Oliver Reimann, Erlangen (DE); Wolfgang Voss, Oberreichenbach (DE)

(73) Assignees: Siemens Energy Global GmbH & Co. KG, Munich, Bayern (DE); Siemens Energy AS, Oslo (NO)

(21) Appl. No.: 18/016,336

(22) PCT Filed: Jul. 21, 2021
(86) PCT No.: PCT/EP2021/070370

§ 371 Date: Jan. 14, 2023

(30) Foreign Application Priority Data
Jul. 23, 2020 (GB) 2011388.2

(51) Int. Cl. H02J 1/10; H02J 7/00; H02J 1/02

(52) U.S. Cl. CPC H02J 1/10; H02J 7/0013; H02J 7/0063; H02J 1/02; H02J 2310/42

(57) ABSTRACT

An MV DC electrical energy distribution system includes two or more MV DC buses, coupled together in normal operation by a solid state switch. Each MV DC bus is adapted to be electrically coupled to one or more consumers. Each MV DC bus is coupled to one or more MV DC energy storage devices. The MV DC energy storage devices each have a plurality of LV energy storage stacks connected together in series. Each MV DC energy storage device uses a power control unit to distribute the power between different MV DC energy storage strings or to control the power of each MV-energy storage devices individually.

### CROSS REFERENCE TO RELATED APPLICATIONS

This application is the US National Stage of International Application No. PCT/EP2021/070370 filed 21 Jul. 2021, and claims the benefit thereof. The International Application claims the benefit of United Kingdom Application No. GB 2011388.2 filed 23 Jul. 2020. All of the applications are incorporated by reference herein in their entirety.

### FIELD OF INVENTION

The present disclosure relates to an energy distribution system, in particular for distribution of electric energy on a vessel, or rig, including a ship or platform and to a method of operating an energy distribution system.

### BACKGROUND OF INVENTION

For ships and drilling platforms, diesel-electric propulsion is becoming increasingly popular. Here, the mechanical energy of the diesel or gas turbines is first converted into electrical energy with the help of a generator and then converted back into mechanical energy in the vicinity of the drive (e.g. propeller) with a converter and an electric motor. Further improvements are desirable.

### SUMMARY OF INVENTION

In accordance with a first aspect of the present invention, an MV DC electrical energy distribution system, the system comprising two or more MV DC buses, coupled together in normal operation by a solid state switch; each MV DC bus being adapted to be electrically coupled to one or more consumers; wherein each MV DC bus is coupled to one or more MV DC energy storage devices, the MV DC energy storage devices each comprising a plurality of LV energy storage stacks connected together in series, wherein each MV DC energy storage device uses a power control unit to distribute the power between different MV DC energy storage devices or to control the power of each MV-energy storage devices individually.

The invention uses LV-energy storage stacks and combines them together to form a medium voltage energy storage device, with additional measures.

Each LV energy storage stack may comprise one or more energy storage units; and wherein each energy storage unit comprises a plurality of LV energy storage modules connected together in series. The main challenge here is to symmetrize the LV banks to each other.

When an LV energy storage stack comprises two or more LV energy storage units, the units may be connected together in parallel.

Each LV energy storage stack may operate at up to 1 kV and each LV energy storage module of the stack operates at up to 100V and has a capacity of 60 Ah to 100 Ah.

Each LV-energy storage may use a short circuit protection circuit with MV isolation capability, such as fuses.

Each LV energy storage may use a step down coupler, or half bride, that controls output voltage. This enables a different power flow compared to the other in-series connected LV-energy storage. The step down couplers may be used to switch ON and OFF each LV-energy storage, or battery bank. A short circuit protection with these step down couplers is then possible. to enable a series connection of LV-energy storage devices to form an MV-energy storage device and so balance the energy of each LV stack.

Each LV energy storage may have a separate isolating and earthing device. This is for safe maintenance operation while the other in-series connected LV-Energy storage still operate under load.

The MV DC energy storage devices may further comprise protective switches, connected between the energy storage units and the MV DC bus.

The protective switches may comprise at least one of solid-state circuit breakers, fuses, in particular pyro fuses, or melting fuses, or IGBTs.

The MV DC energy storage devices may further comprise harmonic compensators, in particular active harmonic filters, between the MV DC energy storage units and the MV DC bus. These filters extend the battery lifetime.

Each MV DC energy storage device may uses a power control unit to distribute the power between different my dc energy storage strings.

This may be done via additional isolated DC to DC converters or through an additional distribution LV-Bus. The distribution of the power is between the strings, rather than just in a single string).

A plurality of MV DC energy storage devices on at least one of the MV DC buses may be connected together in parallel.

The one or more MV DC buses may be coupled together by a first DC/DC converter comprising a first parallel transistor diode inductor arrangement connected in series with a second parallel transistor diode inductor arrangement; and a second DC/DC converter comprising a first parallel transistor diode inductor arrangement connected in series with a second parallel transistor diode inductor arrangement, the DC to DC converters being coupled together by a bus tie.

The MV DC buses may comprise fixed or floating DC buses. These buses couple to MV-DC energy storage with a power controller

For a stable bus, a chopper is required to ensure that the voltage in the stacks of the energy storage device matches the bus voltage, whereas a floating voltage DC bus allows the chopper to be omitted and the bus voltage may vary around a nominal value.

The MV DC buses may operate at a voltage in the range of 4.5 kV to 18 kV, in particular 6 kV to 10 kV.

The discharge rate (C-rate) may be between 0.1 and 2, typically 0.1, or the charging rate may be between 0.1 and 2, typically 0.2

The capacity of each energy storage device may be in the range of 60 Ah to 1000 Ah and 6 kV.

The system may further comprise one or more AC to DC converters coupled to the two or more MV DC buses.

This enables the MV DC buses to be supplied from an AC power source, such as an AC grid, or LNG engines, to recharge the MV DC energy storage devices.

The system may further comprise an LV DC ring comprising first and second or more LV DC buses connected together by switches, each LV DC bus being adapted to be coupled to one or more consumers.

The switches may comprise semiconductor switches, in particular a pair of series connected transistors. This provides protection for the MV DC batteries.

One or more energy storage devices may be coupled to each of the LV DC buses of the LV DC ring.

The LV DC buses may operate at a voltage in the range of 100V to 1.5 kV.

The system may comprise at least a primary energy source; wherein the primary energy source comprises one of an AC grid, in particular a shore supply; or an onboard energy source and an AC generator, in particular a liquified natural gas powered onboard energy source, connected to each MV DC bus through an AC to DC converter.

The system may further comprise a transformer and an AC to DC converter whereby the shore supply is adapted to be coupled directly to the LV DC buses of the LV DC ring.

The energy storage may comprise one of a battery, bank of batteries, capacitors, supercapacitors, or flywheels, redox flow cells, or fuel cells. Each may further comprise a power controller or/and semiconductor switch and/or pyrofuse.

### BRIEF DESCRIPTION OF THE DRAWINGS

An example of a system according to the present invention will now be described with reference to the accompanying drawings in which:

FIG. 1 illustrates an example of a conventional medium voltage AC setup, for example for a cruise liner;

FIG. 2 illustrates a first example of a medium voltage DC energy storage and distribution arrangement in accordance with the present invention;

FIG. 3 illustrates one implementation within a medium voltage DC grid in accordance with the present invention;

FIG. 4 illustrates an alternative implementation within a medium voltage DC grid in accordance with the present invention;

FIGS. 5a and 5b illustrate modifications to the implementation of FIG. 3;

FIG. 6 illustrates a modification to the example of FIG. 5b;

FIG. 7 illustrates an implementation with similar functionality to that of FIG. 6;

FIG. 8 illustrates an embodiment of a medium voltage DC grid in accordance with the present invention; and,

FIG. 9 illustrates an embodiment of a fully electric medium voltage DC grid in accordance with the present invention.

### DETAILED DESCRIPTION OF INVENTION

Diesel electric systems for vessels, drilling rigs or other types of offshore structure typically require some way to distribute the energy that has been generated. For rigs, in particular, this has conventionally been by means of AC grids alone. For vessels, such as cruise liners, or ferries, AC grids have been preferred. For higher availability these AC grids may be connected in a closed ring configuration. Use of AC ring installations is more common for medium voltage (MV) AC solutions. Operation in a closed ring configuration, with normally closed bus ties, is possible provided that the bus tie coupler and the protection scheme can be shown to ensure a safe disconnection between two zones in case of failure. Regulatory requirements in this respect are quite strict.

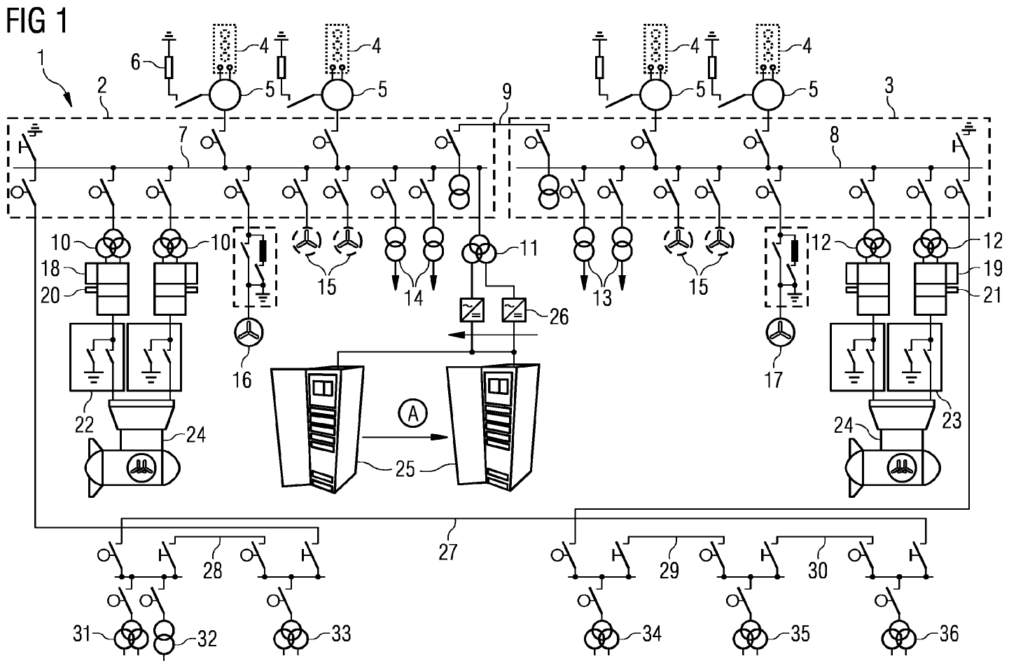

FIG. 1 illustrates an example of a conventional MV AC setup, for a vessel, such as a cruise liner. The AC grid 1 comprises two zones 2, 3, each comprising an AC switchboard 7, 8, the switchboards being connected together by a coupling or bus tie 9 having galvanic isolation switches at each end, for example solenoid motor operated switches. Each switchboard is fed by one or more prime movers 4, e.g. a diesel engine, which drive a generator 5. The generator is connected through a switch and a earth resistor to ground 6. Each AC switchboard 7, 8 may be connected in a ring configuration via line 27, which may include couplings 28, 29, 30 between subsidiary switchboards connected by switches to transformers 31, 32, 33, 34, 35, 36. These transformers allow the voltage to be transformed to a voltage suitable for the requirement of the low voltage hotel loads connected to them (not shown). For this example, the main AC installation is 11 kV, 60 Hz, with an 11 kV ring through the vessel, with a transformer in each zone to transform down from 11 kV to 690V or 440 V AC, as required.

Each AC switchboard 7, 8 is also coupled via switches to consumers of different types. For example, standard consumers, such as thrusters and other propulsion 15, 16, 24, are connected by switches to the switchboard 7. In the case of the propulsion 24, it is connected to the switchboard 7 through a switch, a transformer 10, 12 rectifier 18, 19 brake chopper 20, 21 and motor disconnector and earthing 22, 23. Another connection to the switchboard 7, 8 through distribution transformers 13, 14 may be to thrusters, such as a bow thruster for manoeuvring. Thrusters 16, 17 may be connected through an AC disconnector and earthing via a switch to the switchboard 7, 8. In addition, the switchboard 7 may be connected to a battery installation 25 via a DC/AC converter 26 and a transformer 11 towards the 11 kV AC grid. For each battery cabinet 25, there is a corresponding DC/AC converter 26. Only two cabinets are shown in this example, but there may be more in any such installation. Conventionally such vessels have used diesel engines, but some now have liquified national gas as the primary propulsion. As the liquified national gas engine is generally weaker than a diesel engine (less torque?), an auxiliary diesel generator may be provided for situations in which the LNG power is insufficient. In certain circumstances, those higher load changes may cause the diesel generators to kick in in circumstances where use of diesel is not permitted, for example when manoeuvring power for the thrusters exceeds the power available from the LNG engines. To address this, for example, in harbours where emissions are regulated, LV batteries may be retrofitted. However, LV batteries may not be sufficient in some circumstances, when relied on as a short-term alternative to the LNG, or a top up. LV-Batteries have limited power, so they need to be stepped up as close as possible to medium voltage. This can be done via a DC-to AC converter and a transformer, but this setup has big losses and a huge footprint for the transformers, so is not a particularly desirable option. The general pressure to reduce emissions and operate more sustainably means that it is desirable to address the limitations of LV battery power.

Another issue is that such vessels having docked, need to stop using onboard power and connect to a shore grid. If the vessel is to connect to shore power, then the shore connection needs to be made via a shore station converter to convert from the 60 Hz onboard grid to a typical 50 Hz land grid. This shore side installation is expensive to provide and suffers from technical issues in that the shore station converter needs to supply a short circuit current that is needed for a full function of the selectivity for the AC protection devices. This means that the size of the converter is mainly driven by the short circuit capability, rather than by the nominal power transfer requirement. The converter has to be designed to fit to various vessel types and sizes for the power rating, as well as the short circuit availability and for cruise liners operating globally and a suitable shore power plug needs to be available in all harbours that the vessel visits, which is unlikely to be the case. All these aspects mean that it can be a problem to make shore power available compatible with vessel AC grids.

There are some examples of the use of a low voltage (LV) DC grid solution on vessels, to provide for power flow between connected sources and consumers. For example, for local ferries, with fast charging at each end of a short journey, but the volume of batteries required make this unrealistic for larger vessels over longer distances, other than for limited manoeuvring function, such as in harbours. Typically, fast DC solid state breakers are installed between protection zones on the vessel. For higher efficiency, it is possible to provide LV energy storage solutions, such as batteries, connected to the LV-DC grid within the zones. Other energy storage options include redox flow cells, fuel cells and flywheels. The energy storage within the LV DC grid may be connected either directly to the grid, or indirectly, via a DC/DC converter. The power flow may be routed directly to consumers, such as propulsion or thrusters, or other onboard consumers and hotel loads, provided that these consumers are below 3 to 5 MW, which is within the range that can be fed by the LV grid. A realistic power value per propulsion or thruster load is about 3 MW due to cable costs, which means that the battery power per connection point is limited. There is a desire to provide energy storage at higher voltage levels, such as for MV AC grids and in this case, the energy storage may be connected via a DC/AC converter and a transformer to the MV AC grid, within an existing MV AC solution.

As the requirement for vessel electrical grids moves away from AC-grid solutions to DC-grid solutions to provide power flow between different sources and consumers, there is a corresponding move of drive technologies from LV-DC solutions, typically, with terminal voltage and system voltage up to 1000V DC to 1500V DC, towards MV-DC solutions, typically around 4500V DC to 6000V DC and further up to 18,000V DC. A common voltage level is likely to be around 6000V DC, as this was previously a common DC voltage used in drives that are operating with 4.16 kV AC. Thus, providing energy storage in an MV grid enables energy storage to be used to feed thrusters or propulsion and other bigger loads, such as compressors, high power auxiliaries, on more powerful and bigger ships and rigs.

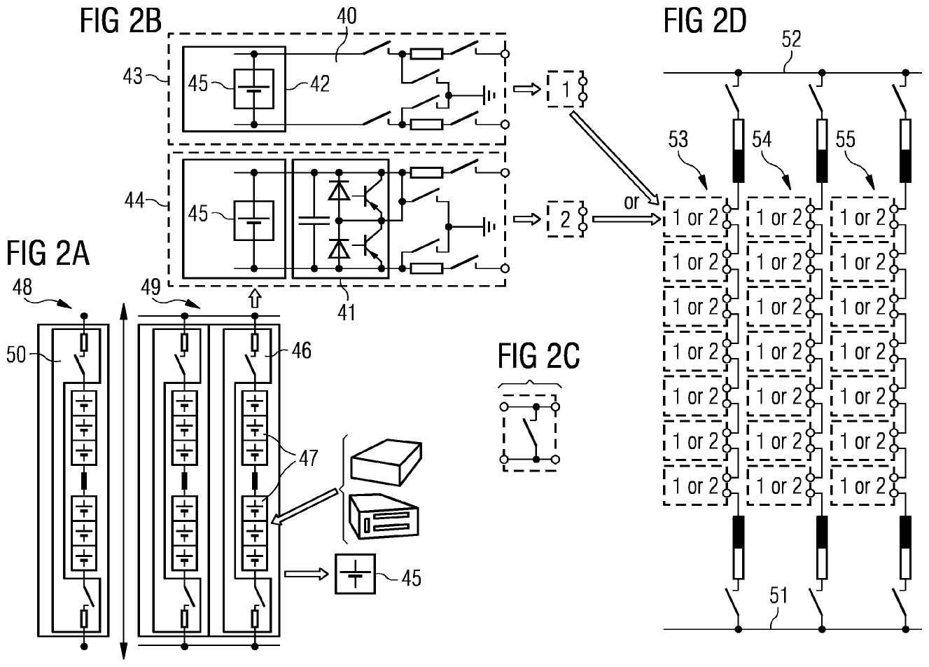

FIGS. 2a to 2d illustrate an example of an MV battery bank which may be installed as part of an MV DC grid in a system according to the present invention. By installing an MV DC grid, it is also possible to provide an LV DC grid for smaller power consumers, for example by a connection via an MV DC/LV DC converter that is based on a dual active bridge and a high frequency transformer. By using MV DC distribution the required currents are reduced, as compared with LV DC distribution solutions, which has a positive impact on the required installed cable or busbars, so less copper is needed, reducing costs and the losses are much lower, so operation is more efficient. There are also benefits from simplification of the installation and reducing the space that is required for the AC cables to the propeller or thruster, as well as the generator. The examples below are described for batteries, as for larger vessels, the battery is the backbone to provide energy balance. Other possible sources include fuel cells, or redox flow cells, for example, used as an additional long term energy source.

Supplying large vessels using purely LV energy storage is not practical, in terms of space and cost of implementation. However, this problem is addressed by forming an MV energy storage system using LV battery stacks, or cubicles. As can be seen in FIG. 2a, a single LV battery unit 48, or double LV battery unit 49, may comprise a fast semiconductor DC fuse 46, such as a melting fuse, or pyro fuse, in series with a DC switch 50, at each end of a plurality of series connected energy storage modules 47, for example operating at 100V, 6.6 Ah or higher. The battery unit 48, 49 of the multiple series connected energy storage modules 47 may typically operate at 1000 V, n×60 Ah or higher. Multiple single LV battery units 48 may be connected together to form the parallel LV battery unit 49, although only two are shown in this example. This arrangement enables a greater installed battery energy to be provided more efficiently. This makes a fully electric cruise liner or other passenger or container vessel a more realistic prospect and by locating battery installation where the energy is needed, then there are fewer losses through transformations. This is particularly relevant for battery charging in harbour, as there is often less time for charging when docked, then the time for discharging by using power for propulsion of the vessel. The given inductor between the energy storage modules 47, leads to a good voltage split in case of a short circuit in the medium voltage busbar, so that all series connected LV-strings do not exceed their individual voltage limits.

FIG. 2b illustrates these elements incorporated into a battery stack 43, 44, with the elements needed for connection to the MV DC bus 51, 52. The LV battery rack 45 represents whichever format of unit 48, 49 has been chosen operating at 1000V, n×60 Ah or higher, in this example. The units 48, 49 are formed into LV DC stacks 43, 44, which may take one of two formats. Format no.1 comprises one or more battery racks 42, 45 with a direct connection to LV fuses 40 and circuitry and to the MV DC grid. A disconnection switch and optional earthing switch are shown. A semiconductor fuse or a pyro semiconductor fuse may be used to protect against short circuits. Format no.2 comprises one or more battery racks 45, each with a connection through a chopper 41, or half bridge converter, to the LV fuses and circuitry 40. This allows independent charging and discharging of each LV battery stack connected in series, or charging and discharging of the whole string.

The series connected LV energy storage may be symmetrized too. An advantageous embodiment has more LV-strings than needed, e.g., ten 1000V strings for a 6000V System). So, there is no immediate pressure to decide which battery is to be charged or discharged. This reduces the effort for the medium voltage protection system and extends the usable battery capacity. This arrangement optimises utilization and live time, but there are additional losses from the half bridge. These losses may be significantly reduced by using the procedure described above, i.e., to provide more voltage in the strings than the total design system voltage requires, thereby allowing optimisation of the charging and discharging. Furthermore, the IGBT may be blocked in the event of a failure in the MVDC side, or other LV energy storage connected in series, to act as an additional protection device.

Each of these battery stacks may be connected in series with another of the same format, as shown in FIG. 2d, to form an MV DC energy storage device 53, 54, 55. Thus, each LV DC battery stack 43, 44 may be connected through the fuses and circuitry 40 to another LV DC stack 43, 44 to form an MV DC energy storage device and the energy storage device is connected via MV DC fuses and/or converters to the MV DC bus. For format no.1, the MV DC bus is a floating MV DC bus. For formal no.2 the MV DC bus is a steady, rather than a floating bus. Optionally, a pyro bypass may be added between the LV fuse circuitry 40 and the next LV DC stack 43, 44 (or for the final stack, to the fuses and/or converters to the MV DC bus), as shown in FIG. 2c. This allows a redundant LV DC stack 43, 44 of the appropriate type to be added in each MV DC energy storage device 53, 54, 55 connected to the MV DC bus and if any of the energy storage modules or units fail in the stack, then this bypass operates to take the faulty stack, out of the series connected stacks without affecting the overall energy storage device 53, 54, 55. This method may also be used instead of a half bridge to switch on, or switch off, the series connected energy storage, e.g., the ten 1000V Batteries for a 6000V MV system

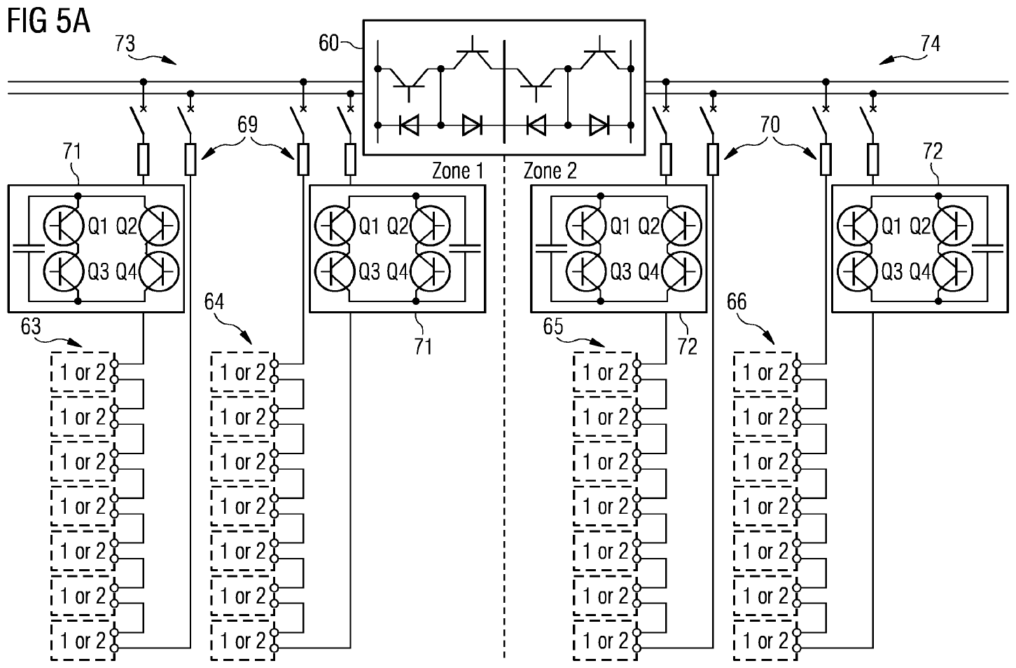

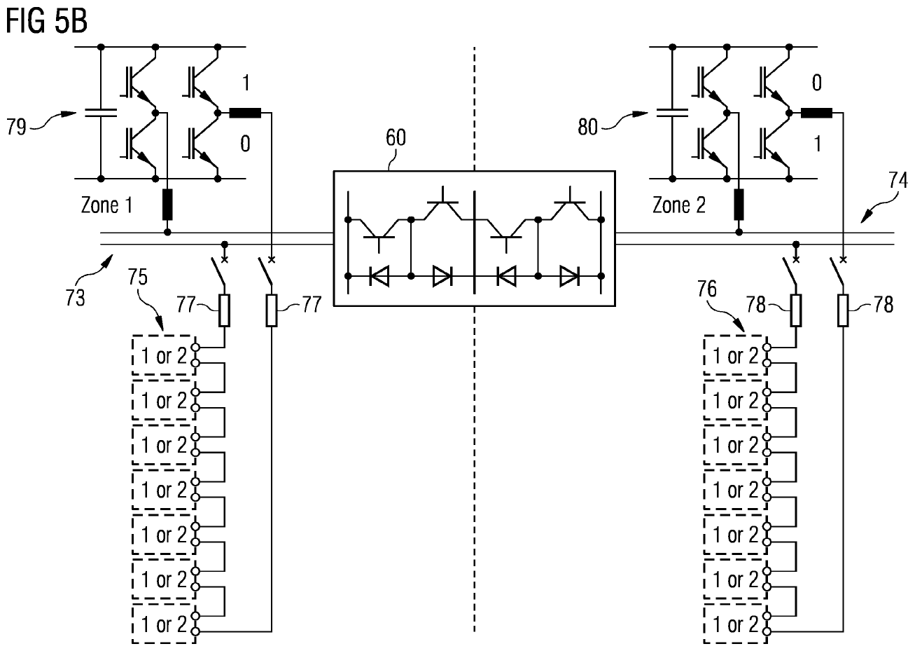

The MV DC energy storage devices illustrated in FIG. 2d each comprise only one type of LV DC stack 43, 44, i.e., with or without a chopper, to allow connection to a steady, or fixed, MV DC bus. The serial connection of the LV DC battery stacks 43, 44 required to reach the MV DC level, 6 kV in this example, is either with n-number of LV DC battery stacks and no bypass switch (FIG. 2c), or with n+1-number of LV DC battery stacks, each having a bypass switch. The further LV Battery strings (n+1) provide for redundancy and in this case a short circuit device, for example a pyrotechnically operated closing switch, may be added to short circuit a failed LV batteries string, after the string has been disconnected, allowing it to continue to operate. The additional function of ultra-fast disconnection of the battery string provides increased safety, but with some additional losses from the MV SSCB. For each 6 kV line-up a reactor may be provided as a passive filter, or to limit the short circuit current gradient. A pyro semiconductor fuse may be provided for short circuit protection, with a disconnector switch before connecting to the 6KV DC. Although 6 kV DC is an example of a suitable MVDC voltage, the solution is also suitable over a wider range of MVDC voltages e.g. from 3 kV to 12 kV+. The dual active bridge used as an active filter, FIG. 5a, for limiting the harmonics for the MV battery increases the live time, but causes some additional losses.

The LV DC battery stacks connected to form an MV DC power distribution system have power connection to plus and minus 51, 52 on the MV DC bus through MV DC fuses at each end. In addition, cooling connections (not shown), typically water connections for a water-cooled battery solution, or air cooling for low current rate solutions, are provided, as well as an air-duct (not shown) for exhaust gases in case of a thermal runaway. An auxiliary power supply may be provided internally in the LV battery module, using the LV battery cells voltage for the control devices in one LV-battery string. Communication between the various stacks, racks, modules and the LV-Battery string to the main controller, may be via industrial WLAN or optical fibre communication. The arrangement shown for the MV DC energy storage device may be kept relatively simple and cable costs can be kept down by reducing the connections required.

An MV DC electrical energy distribution system may be assembled from two or more MV DC buses, by coupling the two or more MV DC buses together in normal operation via a solid state switch. Each MV DC bus is adapted to be electrically coupled to one or more consumers. The method of assembling includes coupling each MV DC bus to one or more MV DC energy storage devices. These MV DC energy storage devices each comprise a plurality of LV energy storage stacks connected together in series. Thus, by connecting a plurality of LV energy storage stacks together in series, each MV DC energy storage device is formed. Each MV DC energy storage device so formed, uses a power control unit to distribute the power between different MV DC energy storage strings or to control the power of each MV energy storage string individually.

Reducing emissions of vessels is highly desirable and for cruise liners which may enter environmentally sensitive areas, the facility to operate in a completely emission free manner is of even greater importance. The medium voltage energy storage solution described enables passenger vessels to achieve this operational requirement. The energy storage installation described makes it possible to meet the very high energy requirement of cruise liners or other such vessels, which is typically double-digit MWh, up to more than 1000 MWh, whilst remaining emission free—at least at the point of use. This can be achieved by operating the battery cells of the energy storage device as energy batteries by choosing to have a low discharge current rate (C-rate), typically less than 1, more commonly about 0.1, so that the time for which they are able to supply power is increased, but the current is reduced. A corresponding charging rate may be about 0.2. Alternatively, in some applications, such as land based fast charging, where recharging may be done via the AC grid, for example, for electric vehicles, the C-rate is chosen to be high, perhaps C equal to 20 or 30, so that the energy storage is in effect a power battery, rather than an energy battery, with a high current, but only a relatively short period before the capacity is exhausted.

The cooling systems may be designed to be as simple as possible, for example, with water-cooling using only a simple internal circulation or an air-cooled system. The battery modules may include features designed to avoid propagation of thermal runaway in one cell to another neighbouring cell, such as described in GB2561211. Exhaust gases from the cells are extracted from the battery room into a safe external area using exhaust channels connected to each module.

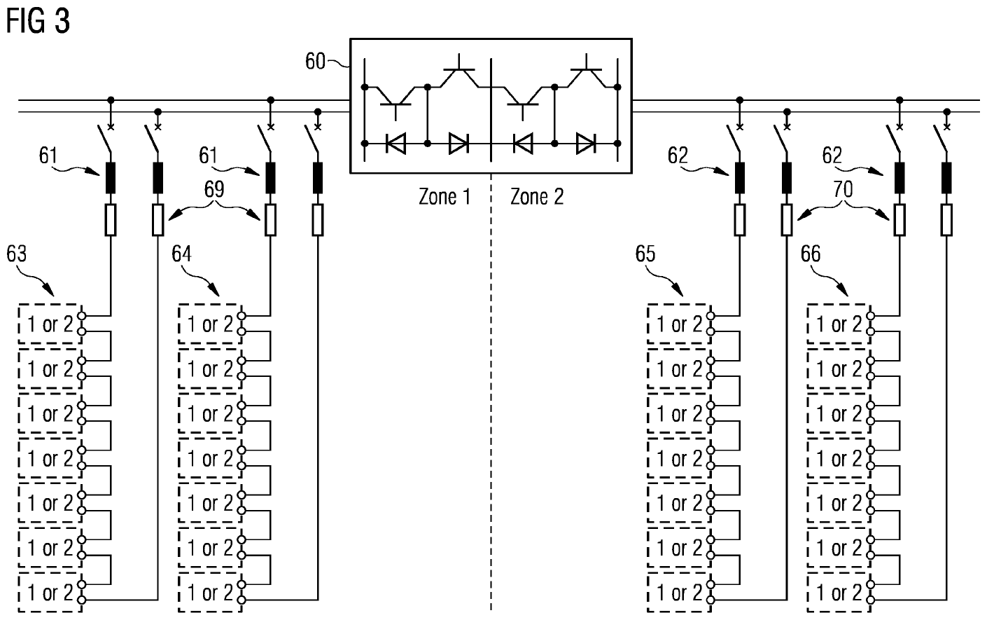

Short circuit protection may be integrated within the LV DC battery units using conventional semiconductor fuses or with pyro-semiconductor fuses 46, 40. Pyro-semiconductor fuses are electronically ignited and therefore may be easier to design independently from the load. If an overload current occurs, the classic melting curve of a fuse needs some time depending on the peak current. The pyro-fuse is able to react faster and can be set by an electronic, software based. “melting curve” to get much better sensitivity and selectivity (e.g. the ignition is done only if the overcurrent flows in the positive direction). There are further advantages of the pyro-semiconductor fuse including the need to keep fewer spare parts, as they have a wider current operating range than conventional semiconductor fuses and the pyro-semiconductor fuses have faster disconnection, so are able to start current limiting after less than 50 μs, as well as having lower losses than a melting semiconductor fuse. The very fast reaction time of a pyro-fuse reduces the thermal energy within the pyro-fuse during opening the overcurrent. Reducing losses is particularly important for battery operation. Pyro semiconductor fuses 69, 70 to provide this short circuit protection are illustrated in FIG. 3 for example. In addition, an inductive harmonic filter 61, 62 may be added in series between MV DC bus, in this case a 6 kV floating MV DC bus and the fuses 69, 70 to limit harmonics towards the energy storage devices 63, 64, 65, 66 and in this example, their battery cells.

In the example of FIG. 3 and subsequent examples, equal numbers of energy storage devices 63, 64, 65, 66 are shown on the MV DC buses on either side of a fast MV solid state circuit breaker 60, allowing different zones of the vessel to have independent energy storage devices, even if a fault on one side causes the circuit breaker to open and separate the buses. However, in all of the examples, the number of energy storage devices on each MV DC bus does not have to be the same, there could be odd or even numbers of energy storage devices on each bus, each containing odd or even numbers of battery stacks, and there may be different numbers of energy storage devices on each MV DC bus. Typically, for a 6 kV MV DC bus, the energy storage devices may be rated for anything from 60 A to 1000 A. The implementation of parallel MV battery strings within a MVDC grid illustrated shows two zones shown, although there may be more zones and more parallel MV battery strings in parallel. For short circuit protection an MV pyro semiconductor fuse may be used and an inductive harmonic filter may be needed to limit the harmonic content towards the MV battery depending on the harmonic distortion of the MVDC bus. Current harmonics have the effect of decreasing the battery lifetime. This filter is optional.

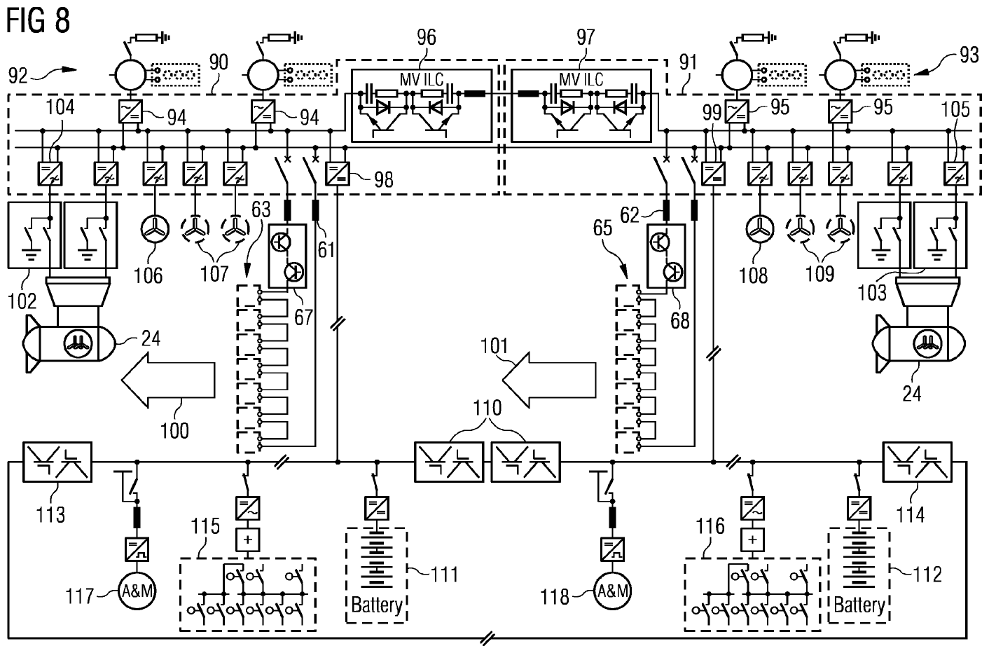

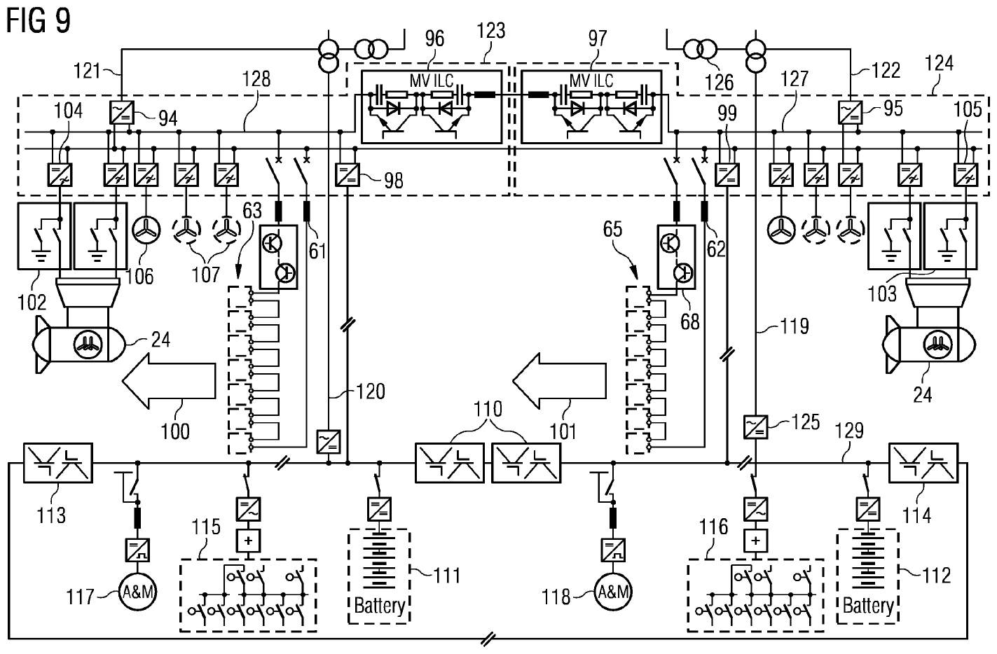

The examples of energy storage devices shown directly connected in series between the plus and minus 51, 52 of the MV DC bus, but for any of the examples described herein, the MV energy storage device may be in the form of a ring, similar to that shown for the LV ring in FIGS. 8 and 9.

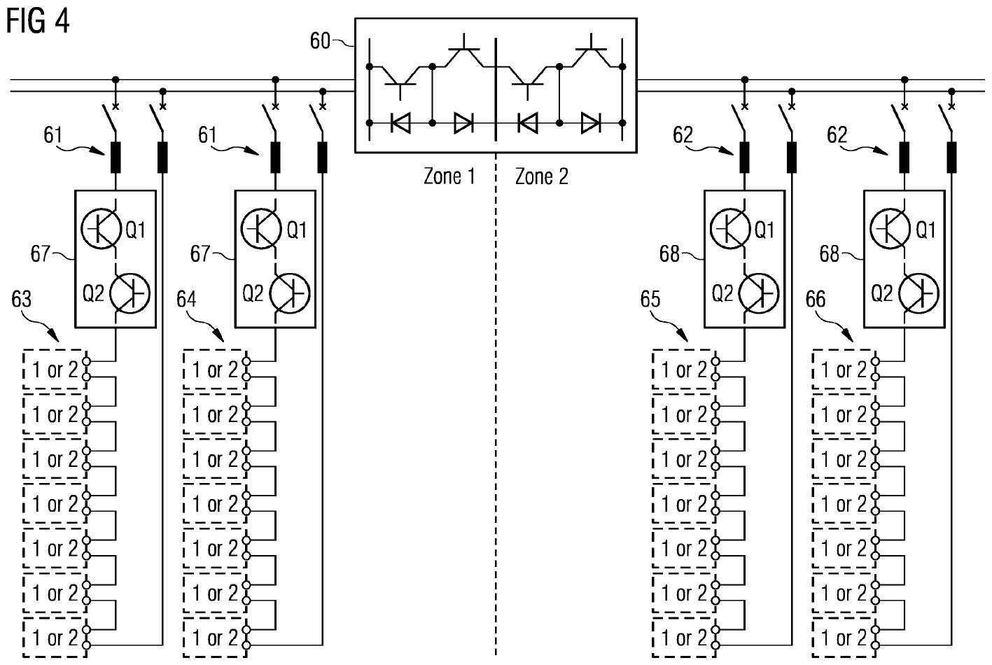

FIG. 4 illustrates an alternative arrangement in which, instead of using MV fuses as a breaker to safely couple the MV energy storage devices 63, 64, 65, 66 to the MV DC bus, high power MV solid state circuit breaker devices 67, 68 such as IGBTs are connected between the energy storage device and the positive rail 51 of the DC bus. In the example shown, for a 6 kV MV DC bus, with a normal operating current of 2000 A, the solid state circuit breakers may comprise two 6.5 kV compact breakers for each energy storage device. The advantage of this is that each MV energy storage device 63, 64, 65, 66 can be connected to or disconnected from the MV DC bus independently of any other MV energy storage device, whereas with a fuse the disconnection is a one off event, although less expensive to manufacture. These circuit breakers provide ultra-fast short circuit protection and allow the each of the MV battery strings to be switched on and off at any time. Each MV DC battery string may have an operating current of between 200 A and 1000 A, according to its voltage. The suggested 6.5 kV IGBT leads to fewer IGBTs compared with the half bridge from FIG. 2b. But each IGBT has a certain flow voltage, so that this version has a much lower steady state ON-losses.

FIGS. 5a and 5b illustrate embodiments in which the inductive harmonic filter is replaced by an active harmonic filter using a dual active bridge. In FIG. 5a, the active filter 71, 72 includes a capacitor to remove voltage ripple disturbance on the grid and so protects the batteries in the MV energy storage device 63, 64, 65, 66. The active filter is designed to be able to switch according to whether the ripple is positive or negative and so equalise the voltage to stop the battery becoming stressed. This has the advantage that it can be dimensioned to cope with the percentage of the voltage that may be attributed to the ripple, rather than having to be dimensioned to cope with the full voltage. The ripple typically does not exceed 10%, so, for a 6 kV MV DC bus, the active filter only has to be designed to cope with a terminal voltage of 600V, which is in the LV range of below 1500 V DC, although the system voltage (voltage to earth, at 6 kV DC is in the MV range. Thus, the bridge comprises a lower cost LV converter, rather than a higher cost MV converter as has conventionally been required to protect an MV AC system. The dual active bridge used as an active filter reduces the voltage ripple for the battery to protect the battery from current harmonics to extend their lifetime. The advantage of this being that the dual active bridge has to be designed only for the maximum level of the ripple voltage and so is still a low voltage device.

Harmonics in the current lead to a pulsating power to the battery. This required energy, which is needed to compensate the harmonics is taken out of the capacitor of the dual active bridge. Short circuit protection may still be provided by an MV pyro semiconductor fuse, as shown in FIG. 5a, or by an MV solid state circuit breaker.

FIG. 5b illustrates an alternative to FIG. 5a, with the same components other than there being a connection from the MV DC bus to an LV bus to provide the active harmonic filtering. In the example of FIG. 5b, there are separate filters 79, 80 for each MV DC energy storage device 75, 76 on their respective MV DC buses 73, 74. The filters are connected to the MV DC bus through fuses 77, 78. The buses may be coupled together in normal operation by the MV DC switch 60, but in the case of a fault on one of the buses, that switch may open to disconnect the buses 73, 74. The active filtering is not affected because each energy storage device has its own filter.

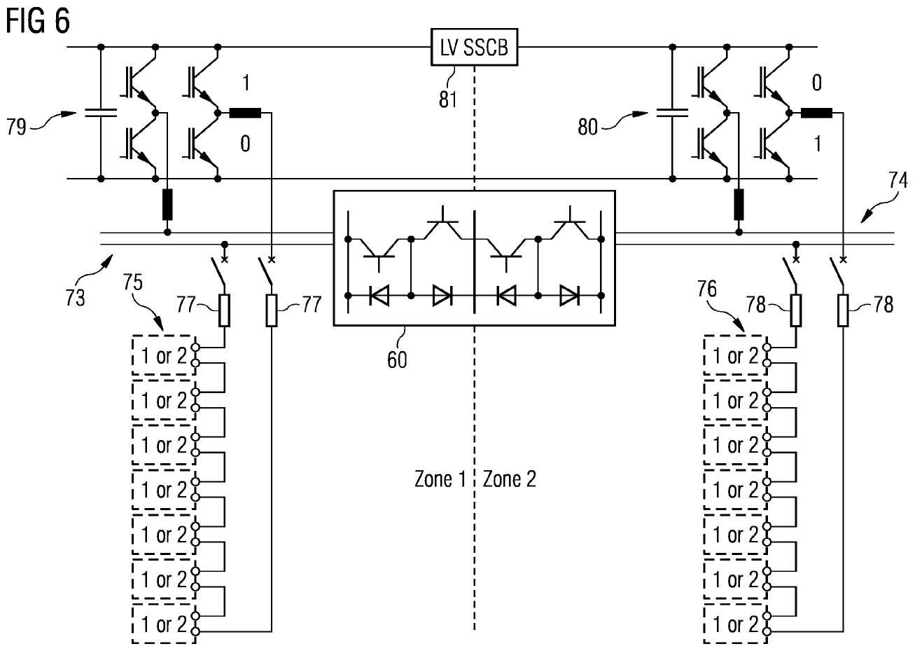

FIG. 6 is an extension of FIG. 5b, but with the LV buses of FIG. 5b connected together by an LV solid state circuit breaker. In both FIGS. 5b and 6, a harmonic filter 79, 80 with converters on an LV DC bus is connected to the MV DC bus 73, 74 to equalise differences in the state of charge of batteries in different energy storage devices 75, 76, but the version in FIG. 6 is able to balance the battery string on Zone 1 and 2 with an additional power flow through the LV-SSCB 81. When the MV breakers 60 open on the MV DC bus, the battery state of charge on each side may start to diverge. The MV DC breaker cannot be re-closed when there is a difference in voltage on either side, so the LV bus connection allows that difference to be corrected. As the recharging of one side or the other is only dealing with a maximum possible difference in charge, rather than the complete charging required to reach the 6 kV capacity, then this is another example of where an LV circuit rated for around 1 kV, i.e. the LV bus and filter, can be used with an otherwise MV DC system, so reducing size, cost and complexity of the equipment required to perform the function. The use of an LV DC breaker 81 between the two sets of LV circuitry, as shown in FIG. 6 is not essential, each MV DC energy storage device may be provided with an associated set of LV circuitry 79, 80, as shown in FIG. 5b, so the LV DC breaker is optional. In both cases a fuse is provided at either end of the series connected stacks. The different dual active bridges of FIG. 6 create an LV DC balancing bus, or active balance network, for example. on a 1000V DC level to allow for the equalization of unbalanced MV battery strings for improvements to battery lifetime and operational performance.

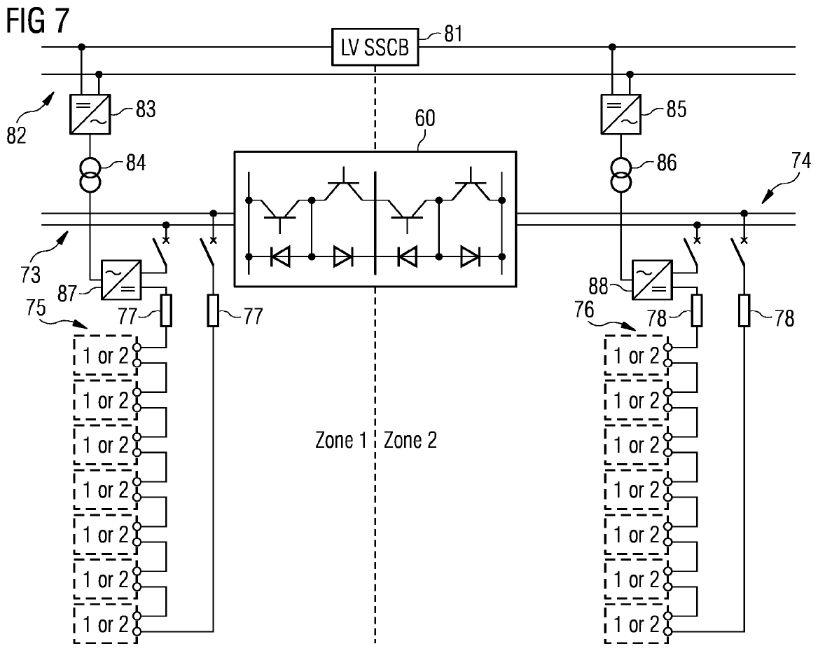

There may be several MV DC energy storage devices, or battery strings, in parallel on the MV DC bus, each with dual active bridges and each of those dual active bridges may be connected via an independent LV DC “balancing” bus. One pole of the MV DC energy storage device, for example the positive or +pole of the MV DC energy storage device, may be connected to the MVDC bus via the dual active bridge to the MVDC bus plus pole. The plus and the minus level of the balancing LV DC bus allows a differential voltage to be created between the different MV batteries and therefore a current flow between the different MV DC devices, so that any imbalance between the MV DC energy storage devices can be equalized. This is also useful if new devices are connected, to bring them to the same voltage as the other MV DC energy storage devices. The advantage of the proposed LV-bus of FIG. 6 is that no isolation transformer is needed for the power transfer, but the disadvantage is that the LV -DC balancing bus system needs the same isolation to earth as the MV-DC System.

Where there are two or more zones, each of these zones may be connected on the MVDC bus to the next by ultra-fast SSCBs for ultra-fast fault clearance, in the event of a short circuit occurring in one zone. Thus, the other zones are protected. Similarly, as shown in FIGS. 6 and 7, this can be implemented within the LV DC balancing bus, using LV SSCBs for fast fault clearance. The voltage on the LV DC balancing bus of FIG. 6 is only used to distribute the energy storage power between the strings. The example of FIG. 7 is an LV-Bus system, with a low voltage isolation to earth, because it uses isolation transformers in the power circuit. With the dual active bridges each zone can be adjusted to the right MVDC voltage level, so that the MVDC SSCBs can be closed again, when the fault has been cleared. In this case an LVDC/LVDC converter may be used. The LVDC/LVDC converter is connected to the underlying LVDC bus (for example, this may be a 1000V DC bus for smaller loads on the vessel). The LVDC/LVDC converter shown in FIG. 7 may be the same type as used in the MVDC/LVDC converter. The LV-DC Balancing bus of FIG. 7 may be used as a normal DC-distribution bus too, so no additional LV-bus is needed for low LV-consumer requirements, a seen in FIG. 8.

FIG. 7 illustrates a low voltage grid, also shown in FIGS. 8 and 9, which may be fed from the MV DC grid. The illustrations of FIGS. 8 and 9 shown that grid as a ring, but they may equally use LV DC buses. In FIG. 7, a DC to DC transformer comprising a DC to AC converter 83, an AC to AC transformer 84 to boost the voltage to MV and an AC to DC converter 87 are coupled between the LV bus 82 and one terminal of the MV DC energy storage device 75 in zone 1. Similarly, a DC to DC transformer comprising a DC to AC converter 85, an AC to AC transformer 86 to boost the voltage to MV and an AC to DC converter 88 are coupled between the LV bus 82 and one terminal of the MV DC energy storage device 75 in zone 2. The DC to DC transformers equalise differences at low voltages and add or subtract the differential voltage to the different energy storage devices, or strings, according to their individual state of charge. The LV DC/LV DC converter implemented within the minus or plus connection of the MV DC energy storage device 75, 76 connection to the MV DC grid 73, 74 provides a more effective and individual equalizing of imbalance in the MV DC energy storage devices 75, 76 to improve lifetime and operational performance by using an LVDC/LVDC converter. This can be implemented as one module of a modular MVDC/LVDC converter.

The implementation of an LVDC/LVDC converter as shown in FIG. 7 allows voltage to be added or removed from the MV DC energy storage device voltage to equalize any imbalance between the different MV DC energy storage devices. In this way, the current of the battery string can be controlled at the optimal level. The LVDC/LVDC converter only needs to be designed for the expected imbalance of DC voltage, for example, up to 1000 V DC and is connected to the underlying 1000V DC grid which is typically installed on a vessel for smaller loads. If the are several zones, then each MVDC bus may be coupled to the next by an ultra-fast MV SSCB. The same connection via an ultra-fast LV SSCB may be used for the LVDC bus.

FIG. 8 shows the implementation into an MV DC setup of a cruise liner, although this could also be applied to any other high-power vessel or rig. In this example the embodiment of FIG. 4, with an MV SSCB connection of the MV energy storage devices is illustrated, but this could equally well use any of the examples of FIGS. 2 to 7 for this part. All of those solutions described hereinbefore may be implemented, but which one is chosen depends upon the relative weighting of cost, efficiency, safety, space etc., for the application. For example, the selection of number of parallel LV battery units and parallel LV battery stacks and parallel MV energy storage devices so formed, may be optimized depending on the required MWh installation, the required redundancy and the cost optimization of the required additional equipment.

FIG. 8 assumes that combustion engines 92, 93 of some type, such as LNG, or gas turbines, are used, with the MV energy storage devices 63, 65 according to the invention allowing a power backup, for example to maintain operation with only one engine in use. In this example, the energy storage devices 63, 65 are coupled to the MV DC bus via harmonic filters 61, 62 and switches 67, 68, but any of the implementations described for FIGS. 2 to 7 may be used. Two zones 90, 91, each with an MV DC bus are provided. The combustion engines 92, 93 feed power via an AC to DC converter 94, 95 onto the MV DC bus. The busses may be connected by MV DC solid state circuit breakers 96, 97. Multiple DC to AC converters 104 provide connections to consumers, such as thrusters 106, 107, 108, 109, or propulsion 24, via DC to AC converters 104, 105 and disconnector/isolator 102, 103 and earthing. Multiple MV DC energy storage devices 63, 65 may be connected together, in parallel, as indicated by arrows 100, 101.

The MV DC energy storage devices allow for peak shaving, so that the required installed engine power may be reduced, as well as supporting the LNG engines when higher power changes or faster time scale are required and charging the batteries in the energy storage devices, with all the advantages described above with respect to the individual aspects. The MV-battery may be used as an emergency diesel function. For example, if the batteries of the MV DC energy storage devices 63, 65 have a low state of charge when the vessel arrives at the harbour, then the MVDC bus would only be able to provide a low voltage level for manoeuvring, which is related to the state of charge of the MV DC energy storage devices. With a high-power charging solution, the voltage between the MV AC grid and the MV DC grid needs to be adjusted for the right current flow. The adjustable voltage is provided with the active converter connected to the LVDC grid and added by the in series connected winding within the MVAC charging line. In this described operation it is required that the power flow for the adjustment will be from the MVAC charging line via the coupling transformer and the active LV converter into the LVDC grid. This power can be used to charge the batteries that are connected to the LVDC grid.

A line from each of the MV DC buses through a DC to DC converter 98,99 supplies an LV DC bus on either side. The LV DC buses are coupled together by suitable solid state switches 110, 113, 114 to form an LV DC ring. Additional energy storage 111, 112 may be coupled to the LV DC ring via a DC/DC converter, as well as LV AC consumers through DC/AC Converters 117, 118 and an auxiliary AC switchboard 115, 116 powered by an DC/AC converter.

On land, as well as high speed charging for cars, the principles may be applied by connecting an MV DC grid to a high voltage AC grid and MV AC grid and high power charging, to supply lights, housing, or industrial areas, as the utilisation of the power grid is doubled in this way because the transformer can be used at 100% with any required redundancy coming from the MV DC grid. A direct connection of an MV DC battery is more efficient than converting from AC at 50% utilisation.

There may also be a desire for a fully electric vessel, for which an entirely LV solution would be impractical in terms of space on board the vessel, or thick heavy cabling that is required at low voltages. The MV DC energy storage devices and power distribution systems described overcome this shortfall and make a fully electric cruise liner a realistic option. That fully electric cruise line needs a very, very, high power connection of up to 100 MW. That leads to a direct connection to the high AC voltage land-based grid with much lower harmonic tolerances than the medium voltage AC-grid. FIG. 9 illustrates an example for fully electric vessel, or rig, or a land based application. In FIG. 9, the example includes an optimized high power MVDC shore connection, which could be used with any of the embodiments described in FIGS. 2 to 7, or 8. Conventionally, harmonic compensation at high voltage would be expensive, but the rectifier overcomes this. The invention makes use of many LV components in an MV setup and deals with differential voltages, rather than the full voltage. As illustrated in the system figures, FIGS. 8 and 9, the MV battery solution can be combined with LV energy storage devices on a subsidiary LV DC bus. The MVDC bus can be connected via a MVDC/LVDC converter.

The fully electric example of FIG. 9 has similar components to FIG. 8, but without any combustion engine or gas turbine. For cruise liners that are steaming overnight from one harbour to the next and then lie in the harbour during the day to allow their passengers ashore, a fully electric vessel using stored energy is made possible because there is a close enough relationship between the energy usage period and the energy recharging period. Slight difference between the time at sea and the time in harbour would be feasible, with the correct capacity and dimensions of energy storage. There needs to be some relationship between use and charging time, perhaps no more than a factor of 3. Outside that range, an option is to exchange battery units, so a vessel with substantial travel time and short shore stays, such as a coaster, may upgrade to MV DC energy storage devices and exchange those, for example as described in our co-pending patent application no. GB1901581.7. The location of energy storage may be split between the subsidiary LV DC bus and the main MV DC bus, depending on the load requirements as described before. Another option is to use fuel cells, or other environmentally friendly loads on the LVDC bus.

The example of FIG. 9 shows an optimized high-power charging solution and makes the shore connection easier because there is no need for frequency adjustment, if a DC bus on the vessel is used as there is no frequency adjustment needed. The MV DC bus may be used for high power charging, as lower current levels are needed than for charging using an LV DC bus. The high-power charging may be done via a 11 kV or 33 kV AC grid on shore, or up to 110 kV AC on shore. An MV diode rectifier 94 on the MV DC bus, such as a 6 pulse or a 12-pulse rectifier, depending on the grid requirements, may be used and connected via a 6 pulse or 12 pulse transformer to the 11 or 33 kV grid. In line 121, a transformer that is fed on the other side by an active rectifier from the subsidiary LV DC grid is provided and couples via line 120 to the LV DC ring. With this inline transformer a positive or negative voltage may be added to the MVAC voltage. This solution allows the charging current to be controlled and the power factor at the grid connection to be adjusted with the phase shift on the added positive or negative voltage. The active converter 125 on line 119 connected to the LV DC bus only needs to be designed to cope with the required differential voltage, not the full voltage. In operation, energy flows from the shore power through the transformers 126 in line 121, 122 on switchboards 123, 124, through converter 94, 95, positive and negative rails of MV DC bus 127, 128, high power solid state devices 67, 68 and fuses 61, 62 to the energy storage 63, 65, to charge the energy storage. When discharging, the power flows back to the MV DC bus and from there to connected consumers 24, or through the active converter 125 to the LV DC bus and consumers connected to that.

By using the charging connection to an MV DC grid, the only design requirement would be the required operation charging power from shore, which is made easier if the connection can be done on MV AC for example, 11 kV or 33 kV. There is no special short circuit power requirement from shore as the protection scheme is fully independent for the shore supply. The solution of FIG. 9 requires fewer components on the shore, such as converters to adjust the frequency, harmonic filters onshore as it would be required with controlled MV rectifiers and no need for reactive power compensation on shore. As all such components on shore, operating at 11 kV or 33 kV are expensive, this provides significant cost savings.

Using the design of FIG. 9, operation of the vessel such as passenger or container vessels that are 100% operated with energy storage, such as batteries, or batteries with fuel cells, or other environmentally friendly sources are made possible. There is no need for a combustion engine or gas turbine, nor for their accessories such as fuel, fuel tanks, exhaust, generators, gears, oil lubrication etc. This leads to a different optimized ship design and reduced noise, which is particularly beneficial for cruise liners. Space is freed up and maintenance reduced. Vessel efficiency may be improved using environmentally friendly energy generated on shore, such as hydro or wind power, can be used instead of polluting fuels. Implementations using fuel cells would be an alternative, although with high power MV charging, fuel cells would be optional, rather than essential, so a 100% emission free vessel would not be dependent on availability of the fuel of the fuel cell.

Embodiments of the invention have been described with reference to different subject matter. In particular, some embodiments have been described with reference to method type claims whereas other embodiments have been described with reference to apparatus type claims. However, a person skilled in the art will gather from the above and the following description that, unless otherwise notified, in addition to any combination of features belonging to one type of subject matter, any combination of features relating to different subject matter, in particular between features of the method type claims and features of the apparatus type claims is considered to be disclosed by this document too.

It should be noted that the term “comprising” does not exclude other elements or steps and “a” or “an” does not exclude a plurality. Also, elements described in association with different embodiments may be combined. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. It should also be noted that reference signs in the claims should not be construed as limiting the scope of the claims. The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1. An MV DC electrical energy distribution system, comprising:
two or more MV DC buses, coupled together in normal operation by a solid state switch;
wherein each MV DC bus is adapted to be electrically coupled to one or more consumers;
wherein each MV DC bus is coupled to one or more MV DC energy storage devices, the MV DC energy storage devices each comprising a plurality of LV energy storage stacks, connected together in series;
wherein each MV DC energy storage device uses a power control unit to distribute power between different MV DC energy storage devices or to control the power of each MV DC energy storage devices individually.

2. The system according to claim 1,
wherein each LV energy storage stack comprises one or more LV energy storage units; and
wherein each LV energy storage unit comprises a plurality of LV energy storage modules connected together in series.

3. The system according to claim 2,
wherein when an LV energy storage stack comprises two or more LV energy storage units, the LV energy storage units are connected together in parallel.

4. The system according to claim 2,
wherein each LV energy storage stack operates at up to 1 kV and each LV energy storage module of the LV energy storage stack operates at up to 100V and has a capacity of 60 Ah to 100 Ah.

5. The system according to claim 1,
wherein each LV energy storage stack uses a short circuit protection circuit with MV isolation capability, such as fuses, in particular pyro fuse or melting fuse.

6. The system according to claim 2,
wherein each LV energy storage stack uses a step down coupler that controls output voltage of each LV energy storage unit.

7. The system according to claim 1,
wherein each LV energy storage unit has a separate isolating and earthing device.

8. The system according to claim 1,
wherein the MV DC energy storage devices further comprise protective switches, connected between the MV DC energy storage devices and the MV DC bus.

9. The system according to claim 8,
wherein the protective switches comprise at least one of solid-state circuit breakers, fuses, in particular pyro fuses, or melting fuses; or IGBTs.

10. The system according to claim 1,
wherein the MV DC energy storage devices further comprise harmonic compensators, in particular active harmonic filters, between the MV DC energy storage devices and the MV DC bus.

11. The system according to claim 1,
wherein each MV DC energy storage device uses a power control unit to distribute the power between different MV DC energy storage devices.

12. The system according to claim 1,
wherein a plurality of MV DC energy storage devices on at least one of the MV DC buses are connected together in parallel.

13. The system according to claim 1,
wherein the one or more MV DC buses are coupled together by a first DC/DC converter comprising a first parallel transistor diode inductor arrangement connected in series with a second parallel transistor diode inductor arrangement; and a second DC/DC converter comprising a first parallel transistor diode inductor arrangement connected in series with a second parallel transistor diode inductor arrangement, the first and second DC/DC converters being coupled together by a bus tie.

14. The system according to claim 1,
wherein the MV DC buses comprise fixed or floating DC buses.

15. The system according to claim 1,
wherein the MV DC buses operate at a voltage in a range of 4.5 kV to 18 kV, in particular 6 kV to 10 kV.

16. The system according to claim 1,
wherein a discharge rate (C-rate) is between 0.05 and 0.2, or a charging rate is between 0.1 and 0.3.

17. The system according to claim 1,
wherein a capacity of each LV energy storage module is in a range of 60 Ah to 1000 Ah and 6 kV.

18. The system according to claim 1, further comprising:
one or more AC to DC converters coupled to the two or more MV DC buses.

19. The system according to claim 1, further comprising:
an LV DC ring comprising first and second or more LV DC buses connected together by switches, each LV DC bus being adapted to be coupled to one or more consumers.

20. The system according to claim 19,
wherein the switches comprise semiconductor switches, in particular a pair of series connected transistors.

21. The system according to claim 19,
wherein one or more MV DC energy storage devices are coupled to each of the LV DC buses of the LV DC ring.

22. The system according to claim 19,
wherein the LV DC buses operate at a voltage in the range of 100V to 1.5 kV.

23. The system according to claim 1, further comprising:
at least a primary energy source; wherein the primary energy source comprises one of an AC grid, in particular a shore supply; or an onboard energy source and an AC generator, in particular a liquified natural gas powered onboard energy source, connected to each MV DC bus through an AC to DC converter.

24. The system according to claim 19, further comprising:
a transformer and an AC to DC converter whereby a shore supply is adapted to be coupled directly to the LV DC buses of the LV DC ring.

25. The system according to claim 1,
wherein the energy storage comprises one of a battery, bank of batteries, capacitors, supercapacitors, flywheels, redox flow cells, or fuel cells, each further comprising a power controller or/and semiconductor switch and/or pyrofuse.
